(19) United States
(12) Patent Application Publication
(10) Pub. No.: US 2024/0300148 A1
(43) Pub. Date: Sep. 12, 2024

(54) Hollow Dental Molds Configured for High Throughput Cleaning

(71) Applicant: Carbon, Inc., Redwood City, CA (US)

(72) Inventors: Bob E. Feller, San Mateo, CA (US); Alexander D. Denmark, Redwood City, CA (US); Thomas R. Cristiani, Foster City, CA (US)

(21) Appl. No.: 18/667,480

(22) Filed: May 17, 2024

Related U.S. Application Data
(63) Continuation-in-part of application No. PCT/US2023/065985, filed on Apr. 20, 2023.
(60) Provisional application No. 63/333,730, filed on Apr. 22, 2022.
(60) Provisional application No. 63/503,329, filed on May 19, 2023.

(51) Int. Cl. B29C 33/38; A61C 7/08; A61C 13/34; B29C 51/30; B29C 64/106; B29C 64/35; B33Y 10/00; B33Y 40/20; B33Y 80/00

(52) U.S. Cl. CPC B29C 33/3842; A61C 7/08; A61C 13/34; B29C 51/30; B29C 64/35; B33Y 10/00; B33Y 40/20; B33Y 80/00; B29C 64/106; B29K 2995/0026

(57) ABSTRACT

Described herein is a mold in the shape of a dental arch produced by additive manufacturing from a polymerizable resin. The mold includes: an upper portion configured in the shape of a set of teeth; an intermediate portion having a hollow cavity formed therein; a planar base surface portion, the hollow cavity extending through the base surface portion; and a plurality of drain channels extending from the hollow cavity upward through the upper portion, the drain channels configured for draining of residual polymerizable resin from the hollow cavity.

### RELATED APPLICATIONS

This application is a continuation-in-part of International Application No. PCT/US2023/065985, filed Apr. 20, 2023, which claims priority from U.S. Provisional Patent Application No. 63/333,730, filed Apr. 22, 2022. This application also claims priority from U.S. Provisional Patent Application No. 63/503,329, filed May 19, 2023. The disclosures of these applications are incorporated by reference herein in their entireties.

### FIELD

Disclosed are methods and systems for making polymer dental appliances such as dental aligners by thermoforming polymer sheets on additively manufactured molds. Methods of cleaning such molds are also described.

### BACKGROUND

Polymer dental appliances such as clear aligners are made by additively manufacturing a mold in the shape of a patient's dental arch, and then thermoforming a sheet of thermoplastic material over that mold. See, e.g., U.S. Pat. No. 7,261,533. Prior to thermoforming, it is important that residual resin be cleaned from all surfaces of the molds—typically accomplished by washing the molds with ethanol (see, e.g., Van Esbroek, Sharma, Lam and Chin, Method and apparatus for forming an orthodontic aligner, U.S. Pat. No. 10,575,925; see also Graham, Laaker and Barth, Rapid Wash System for Additive Manufacturing, US Patent App. Pub. No. US 2019/0255774).

A problem with washing, however, is that it produces contaminated wash liquids which present further processing problems. A possible alternative is centrifugal cleaning, which has been generally described for additive manufactured objects (Murillo and Dachs, Resin extractor for additive manufacturing, US Patent App. Pub. No. 2021/0086450 (Mar. 25, 2021); Hiatt et al., Method for removing and reclaiming unconsolidated material from substrates following fabrication of objects thereon by programmed material consolidation techniques, US Patent App. Pub. No. 2004/0159340 (Aug. 19, 2004); and Converse et al., Systems and methods for resin recovery in additive manufacturing, PCT Patent App. Pub. No. WO 2020/146000 (Jul. 16, 2020)).

Another problem with additively manufactured thermoforming molds is that the molds themselves are typically discarded. This represents considerable waste of material, and hence it is also desirable to minimize the amount of material from which the mold is made. This might be achievable by making hollow molds. However, centrifugal cleaning hollow molds appears difficult, as the hollow cavities themselves, in addition to the outer surfaces of the mold, must also be cleaned—and centrifugation procedures that are optimized for cleaning the surface of a mold may not be effective in cleaning an interior cavity within the mold. Accordingly, there is a need for new approaches to cleaning hollow molds for use in making dental appliances.

### SUMMARY

Some embodiments of the present invention are directed to a mold in the shape of a dental arch produced by additive manufacturing from a polymerizable resin. The mold includes: an upper portion configured in the shape of a set of teeth: an intermediate portion having a hollow cavity formed therein; a planar base surface portion, the hollow cavity extending through the base surface portion; and a plurality of drain channels extending from the hollow cavity upward through the upper portion, the drain channels configured for draining of residual polymerizable resin from the hollow cavity.

In some embodiments, the hollow cavity extends into the upper portion.

In some embodiments, the hollow cavity displaces at least 30 or 40 percent up to 60 or 80 percent, of the total volume of the mold (as compared to the same mold without said hollow cavity).

In some embodiments, the plurality of drain channels have an average diameter at the upper portion of at least 50, 70, 80, 90, or 100 microns.

In some embodiments, the plurality of drain channels terminate at an exterior surface opening having an average diameter at the upper portion of not more than 300, 400, or 500 microns; and optionally the plurality of drain channels originate at an interior surface opening having an average diameter not less than (and in some embodiments greater than) the average diameter of the exterior surface opening.

In some embodiments, the plurality of drain channels include at least 10, 20, 30, or 40 drain channels.

In some embodiments, the plurality of drain channels comprise not more than 100, 200, or 300 drain channels.

In some embodiments, the plurality of drain channels are oriented, on average, at an angle offset from vertical, with respect to the planar base surface portion, of not more than 5, 10, 15, or 20 degrees (e.g., as measured directly from the interior surface opening to the exterior surface opening).

In some embodiments: the plurality of drain channels are oriented substantially vertically with respect to the planar base surface portion along at least a major portion of the length thereof; and/or at least a portion of the drain channels are oriented substantially perpendicularly with respect to the surface of the upper portion surrounding the exterior surface opening of said drain channel (that is, are oriented normal with respect to the surface, to thereby reduce the diameter of the exterior surface opening, as compared to a surface opening for an entirely vertical drain channel).

In some embodiments, at least a portion of said drain channels include a bend.

In some embodiments, at least a portion of the drain channels are configured in the shape of a residual resin trap (e.g., an “S” shaped trap or a “P” shaped trap).

In some embodiments, the height of the cavity, with respect to the base surface portion, is: (i) substantially the same throughout the arch, or (ii) contoured through the arch in a configuration that, in cooperation with the drain channels, facilitates the flow of residual resin out of the hollow cavity during centrifugation thereof.

In some embodiments, the mold is produced by the process of additive manufacturing from a light polymerizable resin.

Some other embodiments of the present invention are directed to a method of making a plurality of polymer dental appliances. The method includes the steps of: (a) additively manufacturing a plurality of molds as described above from a light polymerizable resin on a build platform surface portion, with the molds oriented horizontally on the build platform with the mold bottom surface portion adhered to the build platform surface portion (directly, or through an intervening release sheet); (b) centrifugally separating residual resin from both the upper surface portion and the hollow cavity of each mold while on the build platform by spinning the build platform around an axis of rotation, with the upper portion of the molds (and/or said build platform surface portion) facing away from the axis of rotation; (c) further curing, concurrently or sequentially, the external surface portion (e.g., said upper portion and said intermediate portion) and the bottom portion of each said plurality of molds with actinic radiation or light (e.g., ultraviolet light); then (d) thermoforming a thermoplastic polymer sheet on each mold external surface portion to produce the plurality of polymer dental appliances; and (e) separating the plurality of polymer dental appliances from each mold.

In some embodiments, the plurality of polymer dental appliances include orthodontic aligners, orthodontic retainers, orthodontic splints, dental night guards, dental bleaching (or whitening) trays, or a combination thereof.

In some embodiments, the plurality of polymer dental appliances include at least one progressive set of dental appliances (e.g., a progressive set of dental aligners) for a specific patient.

In some embodiments, the thermoplastic polymer sheet includes a clear polymer sheet.

In some embodiments, the centrifugally separating step is carried out only by spinning the build platform around an axis of rotation with the upper portion of the at least one mold (and/or said build platform surface portion) facing away from the axis of rotation (that is, without spinning the build platform with the upper portion facing towards the axis of rotation.).

Some other embodiments of the present invention are directed to a method of making a dental appliance thermoforming mold. The method includes the steps of: (a) providing initial object image data representing a mold in the shape of a dental arch, the mold including: (i) an upper portion configured in the shape of a set of teeth; (ii) an intermediate portion, the intermediate portion optionally including a hollow cavity formed therein; and (iii) a planar base surface portion, the hollow cavity when present extending through the base surface portion; (b) providing drain channel data, drain channel instructions, or a combination thereof; (c) optionally generating the hollow cavity in the initial object image data if not previously present therein; and (d) combining (before or after the optionally generating step (c) if included) the initial object image data with the drain channel data, drain channel instructions, or combination thereof to create a modified object image data representing the mold, with the mold now further including: (iv) a plurality of drain channels extending from the hollow cavity upward through the surface portion (e.g., the upper portion) configured for draining of residual polymerizable resin from the hollow cavity.

In some embodiments, the method is carried out in or implemented by a computer.

In some embodiments, the method further includes: (e) additively manufacturing a plurality of molds from a light polymerizable resin and a plurality of the modified object image sequences on a build platform, with each mold oriented horizontally on the build platform with the bottom surface portion adhered to the build platform; and then (f) centrifugally separating residual resin from both the upper portion and the hollow cavity of each mold while on the build platform by spinning the build platform around an axis of rotation, with the upper portion of each said mold facing away from the axis of rotation.

In some embodiments, the method further includes: (g) further curing, concurrently or sequentially, the external surface portion (e.g., said upper portion and said intermediate portion) and the bottom portion of each of the plurality of molds with actinic radiation or light (e.g., ultraviolet light); then (h) thermoforming a thermoplastic polymer sheet on each mold external surface portion to produce said plurality of polymer dental appliances; and (i) separating a plurality of polymer dental appliances from the molds.

In some embodiments, the hollow cavity extends into the upper portion.

In some embodiments, the hollow cavity displaces at least 30 or 40 percent up to 60 or 80 percent, of the total volume of said mold (as compared to the same mold without the hollow cavity).

In some embodiments, the plurality of drain channels have an average diameter at the upper portion of at least 50, 70, 80, 90, or 100 microns.

In some embodiments, the plurality of drain channels terminate at an exterior surface opening having an average diameter at the upper portion of not more than 300, 400, or 500 microns; and optionally wherein the plurality of drain channels originate at an interior surface opening having an average diameter not less than (and in some embodiments greater than) the average diameter of the exterior surface opening.

In some embodiments, the plurality of drain channels include at least 10, 20, 30, or 40 drain channels.

In some embodiments, the plurality of drain channels include not more than 100, 200, or 300 drain channels.

In some embodiments, the plurality of drain channels are oriented, on average, at an angle offset from vertical, with respect to said planar base surface portion, of not more than 5, 10, 15, or 20 degrees (e.g., as measured directly from the interior surface opening to the exterior surface opening).

In some embodiments: the plurality of drain channels are oriented substantially vertically with respect to the planar base surface portion along at least a major portion of the length thereof; and/or at least a portion of the drain channels are oriented substantially perpendicularly with respect to the surface of the upper portion surrounding the exterior surface opening of said drain channel (that is, are oriented normal with respect to the surface, to thereby reduce the diameter of the exterior surface opening, as compared to a surface opening for an entirely vertical drain channel).

In some embodiments, at least a portion of the drain channels include a bend.

In some embodiments, at least a portion of the drain channels are configured in the shape of a residual resin trap (e.g., an “S” shaped trap or a “P” shaped trap).

In some embodiments, the height of the cavity, with respect to the base surface portion, is: (i) substantially the same throughout the arch, or (ii) contoured through the arch in a configuration that, in cooperation with the drain channels, facilitates the flow of residual resin out of the hollow cavity during centrifugation thereof.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 is a perspective view of an additively manufactured thermoforming mold in the shape of a dental arch.

FIG. 2 is a top plan view of the first slice of a thermoforming mold for additive manufacturing on a build platform, showing the hollow portion therein, with regularly dispersed drain holes extending completely therethrough.

FIG. 3 is a top plan view of an additively manufactured thermoforming mold showing, on the outside of the mold, the location of internal maximal (or peak) cavity positions for placement of drain holes.

FIG. 4A is a cross sectional view of the additively manufactured thermoforming mold of FIG. 3, taken along line a-a of FIG. 3.

FIG. 4B is a cross sectional view of an alternate embodiment of an additively manufactured thermoforming mold as described herein.

FIG. 4C is a cross sectional view of a further embodiment of an additively manufactured thermoforming mold as described herein.

FIG. 4D is a cross sectional view of a further embodiment of an additively manufactured thermoforming mold as described herein.

FIG. 5A is a top plan view of the thermoforming mold of FIG. 3, after drain holes are added.

FIG. 5B is an underside view of a thermoforming mold of an embodiment of the invention.

FIG. 5C is a top plan view of a support grid including a lower surface according to an embodiment of the invention.

FIG. 5D is an underside view of a thermoforming mold of an embodiment of the invention.

FIG. 6A is a schematic illustration of a first example of centrifugal separation of resin from additively manufactured molds as described herein.

FIG. 6B is a schematic illustration of a second example of centrifugal separation of resin from additively manufactured molds as described herein.

FIG. 7A is a flow chart illustrating one embodiment of an overall process of making thermoforming molds, and dental appliances, as described herein.

FIG. 7B is a flow chart illustrating an alternative embodiment of a portion of the process set forth in FIG. 7A.

FIGS. 8A and 8B are side cross-sectional views like that of FIGS. 4A-C, with the molds now mounted on a build platform with dashed arrows showing residual resin flow out of the hollow cavity during centrifugal separation (and the dotted arrow showing gas flow into the hollow cavity as resin flows out through an optional vent channel).

FIGS. 9A and 9B are flow charts illustrating methods of forming hollow models according to some embodiments of the invention.

FIG. 10 shows an example of hollow model having drainage paths determined by a method of the present invention.

FIGS. 11A and 11B show molds formed from the drainage channels and hollow cavities of hollow models of embodiments of the invention.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

### 1. Additive Manufacturing.

Suitable additive manufacturing methods and apparatus, including bottom-up and top-down additive versions thereof (generally known as stereolithography or “SLA”) are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, US Patent Application Publication No. 2013/0295212 to Chen et al., and U.S. Pat. No. 5,247,180 to Mitcham and Nelson (Texas Instruments patent describing SLA with micromirror array). The disclosures of these patents and applications are incorporated by reference herein in their entirety.

In some embodiments, the additive manufacturing step is carried out by one of the family of methods sometimes referred to as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of CLIP include, but are not limited to: Batchelder et al., U.S. Patent Application Pub. No. US 2017/0129169 (May 11, 2017); Sun and Lichkus, U.S. Patent Application Pub. No. U.S. 2016/0288376 (Oct. 6, 2016); Willis et al., U.S. Patent Application Pub. No. US 2015/0360419 (Dec. 17, 2015); Lin et al., U.S. Patent Application Pub. No. US 2015/0331402 (Nov. 19, 2015); D. Castanon, Patent Application Pub. No. US 2017/0129167 (May 11, 2017). B. Feller, U.S. Pat App. Pub. No. US 2018/0243976 (published Aug. 30, 2018); M. Panzer and J. Tumbleston, U.S. Patent Application Pub. No. US 2018/0126630 (published May 10, 2018); K. Willis and B. Adzima, U.S. Patent Application Pub. No. U.S. 2018/0290374 (Oct. 11, 2018) L. Robeson et al., PCT Patent Pub. No. WO 2015/164234 (see also U.S. Pat. Nos. 10,259,171 and 10,434,706); and C. Mirkin et al., PCT Patent Pub. No. WO 2017/210298 (see also U.S. Patent Application Pub. No. 2019/0160733).

### 2. Hollow Dental Models.

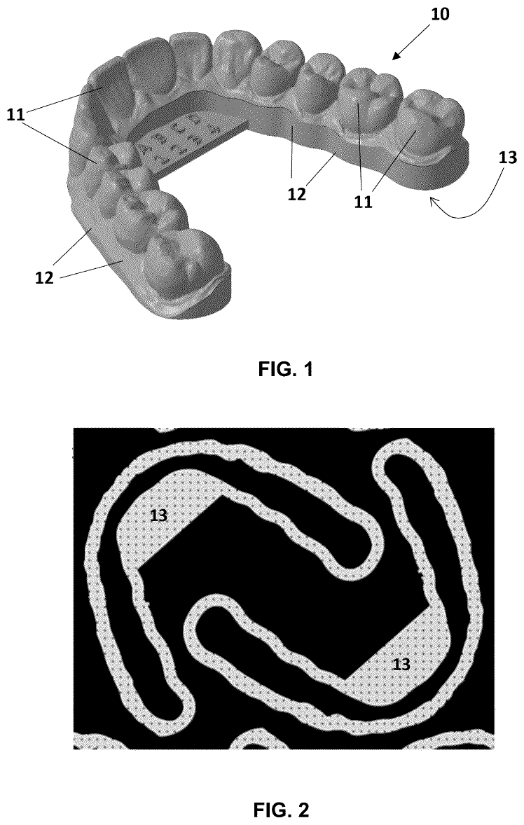

As shown in FIGS. 1-4D, a mold as described herein is in the shape of a dental arch 10. The molds may be produced by additive manufacturing from a light polymerizable resin as described above. The mold includes: an upper portion configured in the shape of a set of teeth 11; an intermediate portion 12 having a hollow cavity 14 formed therein: a planar base surface portion 13, the hollow cavity extending through the base surface portion; and a plurality of drain channels 15 extending from the hollow cavity upward through the upper portion, whereby the drain channels are configured for draining of residual polymerizable resin from the hollow cavity. As used herein, the term “external surface portion” may include the upper portion and the intermediate portion.

The height of the hollow cavity 14, with respect to the base surface portion, can be (i) substantially the same throughout the arch, or (ii) contoured through the arch in a configuration that, in cooperation with the drain channels, facilitates the flow of residual resin out of the hollow cavity during centrifugation thereof. Also, while the illustrations herein show a single continuous hollow cavity, the mold may incorporate a partial cavity with some portions remaining solid, or may incorporate two or more separate cavities. All are intended to be encompassed by the descriptions given herein.

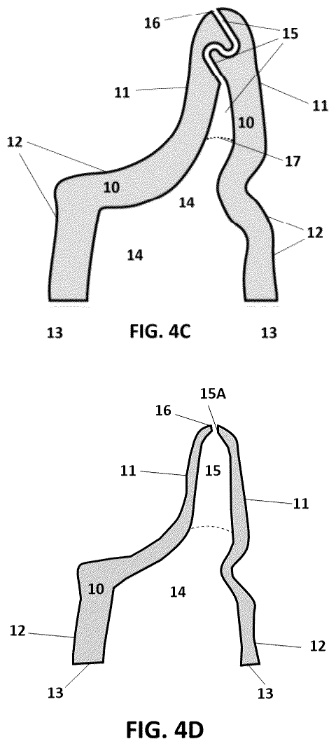

In some embodiments, and as shown in FIGS. 4A-4D, the hollow cavity extends into the upper portion (where the dotted line represents the top or ceiling of the hollow cavity 14 when the drain channels 15 are not included). In some embodiments, the hollow cavity 14 displaces at least 30 or 40 percent up to 60 or 80 percent, of the total volume of the mold (as compared to the same mold without the hollow cavity).

The number of drain channels will depend upon factors such as the size, shape, and position of the drain channels, the viscosity of the additive manufacturing resin, and the speed at which spinning for centrifugal separation is carried out. In general, there are preferably at least 10, 20, 30, or 40 drain channels, and preferably not more than 100, 200, or 300 drain channels.

The average diameter of the drain channels at the upper surface portion (or exterior surface opening 16) may be, in some embodiments, in a range of about 50 microns to about 750 microns. In particular embodiments, the average diameter of the drain channels at the exterior surface opening 16 is at least 50, 70, 80, 90, or 100 microns, and in some embodiments, not more than 300, 400, or 500 microns. In some embodiments, the drain channels also have an interior surface opening 17, which may be the same diameter as the exterior surface opening or may have an average diameter greater than the exterior surface opening 16 as discussed further below. In some embodiments, such as in FIG. 4D, no defined interior surface opening is present and instead the hollow cavity extends through to the drain channel 15, although the diameter of the cavity/channel may decrease as it approaches the exterior surface opening 16. Further, as shown in FIG. 4D, in some embodiments, the drain channel 15 only decreases to the diameter of the exterior surface opening 16 at the regions that are very close to the upper surface portion. For example, in some embodiments, the diameter of the exterior surface opening 16 (e.g., 500 microns) only extends down through the drain channel (see 15A) for a distance of about 100 microns to about 500 microns (e.g., 150, 200, 250, 300, 350, 400 microns, or any range therebetween), and below this distance, the drain channel diameter may increase substantially (e.g., 2, 3, 4, 5, or 10 times or more).

Drain channels 15 and their corresponding exterior surface openings 16 and interior surface openings 17 (when present) can have any suitable profile, including but not limited to round, elliptical, tetrahedral, hexahedral, octahedral, etc., including combinations thereof. Channel profile and average diameter may change along the length of the channel to facilitate resin flow and/or thermoforming of the dental appliance. For example, a narrowing “neck” may be included adjacent the exterior surface opening to reduce the average diameter thereof. In another example, the channel may be funnel-shaped (that is, the interior surface opening larger than the exterior surface opening). The foregoing are not limiting, and any suitable configuration that permits or facilitates the flow of resin out of the internal cavity 14 can be used.

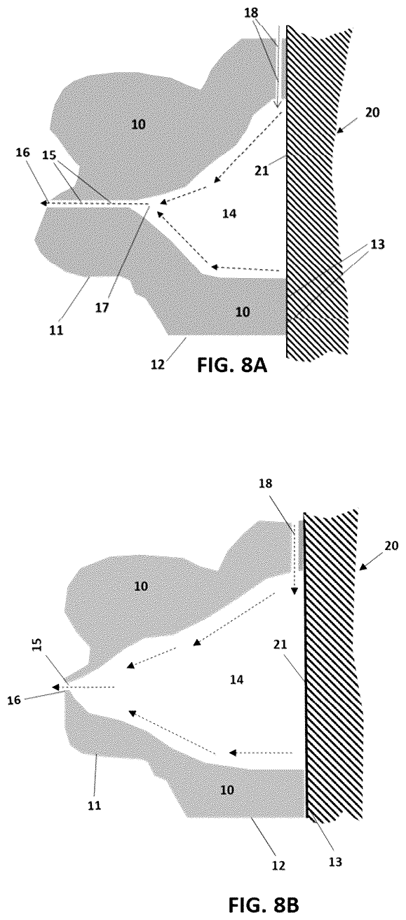

In addition, while not required, in some embodiments a vent channel (18 in FIGS. 8A and 8B) may be included, with the interior surface opening thereof preferably near or adjacent the build platform surface 21, so that the ambient atmosphere may enter the hollow cavity during centrifugal separation and reduce any vacuum forces that might otherwise cause residual resin to be retained therein.

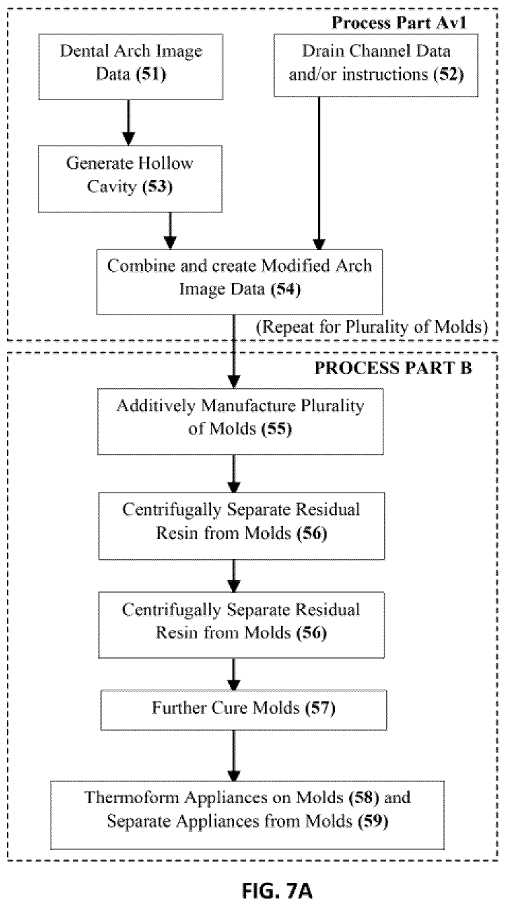

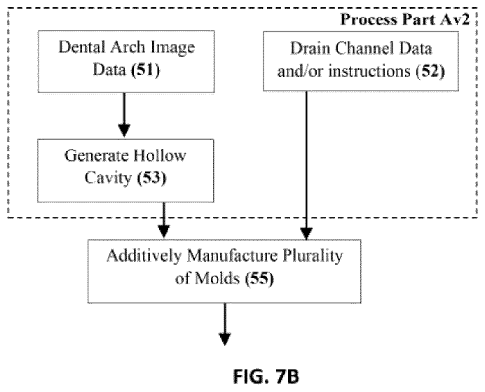

The drain channels may be oriented in a variety of ways. In some examples, the drain channels are oriented substantially vertically with respect to the planar base surface portion for some, all, or at least a major portion of the length thereof. For example, in FIG. 2, which is an image of a first exposure slice of a mold during additive manufacturing thereof, with white regions indicating exposed regions, the drain channels are created as a series of uniformly spaced dots (e.g., “off pixels”) that are uniformly interspersed throughout the image and continue in the same location in every subsequent exposure slice (creating vertical channels from top to bottom). Such “drilling” of channels can be accomplished by any suitable technique, including modification of PNG files during or after slicing of an STL file (as for example shown in FIG. 7B Process Part Av2) by modification of an STL file (as for example shown in FIG. 7A Process Part Av1), or like operations performed on other file types that are alternatives to STL and PNG files.

In other embodiments, some or all of the drain channels need not be oriented perfectly vertically, but may be oriented, on average, at an angle offset from vertical, with respect to the planar base surface portion, of not more than 5, 10, 15, or 20 degrees (e.g., as measured along a line drawn directly from the interior surface opening 17 to the exterior surface opening 16). This may be done, for example, to match interior cavity peaks/high points that are best locations for an interior surface opening to the best location for an exterior surface opening.

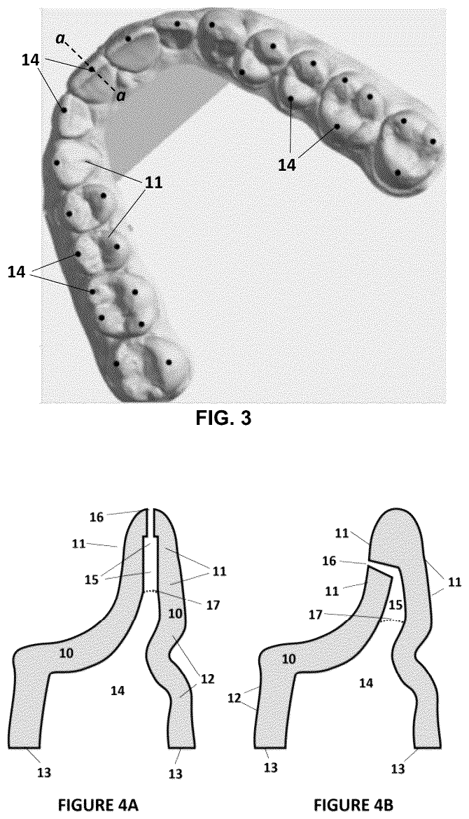

While FIG. 2 illustrates an example where drain channels are uniformly placed, FIGS. 3 and 4A illustrate an example where the drain channels are placed based on interior cavity peaks, or optimum locations for draining the internal cavity. In some situations, however, a purely vertical channel may create an elongate open slot as an exterior surface opening. In this case, it can be preferable to orient a portion of the drain channel substantially perpendicularly with respect to the surface (that is, normal with respect to the surface), to thereby make possible a smaller surface opening. This may be accomplished, for example, by introducing a bend in the drain channel, as shown in FIG. 4B.

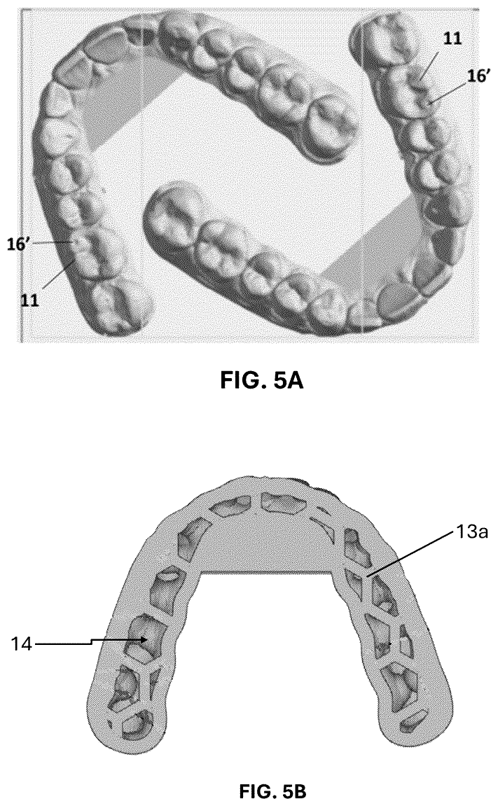

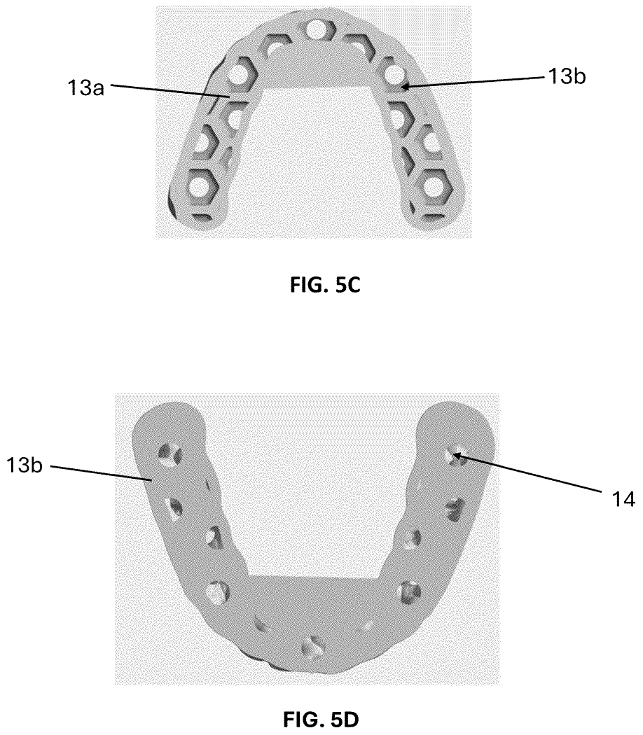

In some cases, a dimple or protrusion may be created in the mold following post-centrifugation curing, due to retained resin being drawn out, as shown in FIG. 5. This can be irrelevant if the dimple 16′ is sufficiently small. In other embodiments however, the surface exit opening 16 can be located where the curvature of the dimple (predetermined from the size of the opening, the size of the channel, and/or the viscosity of the resin) will match the curvature of the adjacent surface. For example, the molds can be held upside down and further cured after centrifugation so that gravity draws out the retained capillary meniscus, which is then cured in a configuration that substantially matches the adjacent mold surfaces.

While drain channels can be configured in any way that facilitates the ejection of resin during centrifugal separation, they can if desired also be designed to include a resin trap to retain resin, as this can serve to advantageously plug the drain channel (e.g., during post-spin curing) and enhance accuracy of the thermoforming step. Traps may be of any suitable configuration, including but not limited to S traps and P traps. The traps need not be established with curved channels (as commonly seen in household plumbing) but may have angles and/or sharp corners, or other shapes that can be conveniently created by additive manufacturing.

As shown in FIG. 5B, the underside of the planar base surface portion 13 may have a number of different configurations, including the presence of one or more support grids 13a formed in and supporting the hollow cavity 14. Such support grids 13a may provide additional stability to the mold. The support grids 13a are typically formed of struts, optionally with at least some struts interconnected. FIG. 5B shows the underside of hollow mold looking through the support grid 13a and into the hollow cavity 14.

In some embodiments, support grid 13a may be further modified to facilitate removal of the model from the build platform. An example is shown in FIGS. 5C-5D. FIG. 5C is a top-down view of support grid 13a without dental arch 10 thereon. In this embodiment, support grid 13a has a lower surface 13b that contacts a build platform (not shown). The lower surface 13b may be tapered from the support grid 13a structure, for example, to form one or more circular, oval, or other structures that make removal of the dental model from a build platform easier relative to the grid support 13a. FIG. 5D shows the underside view of the lower surface 13b of such a dental model with a dental arch (not shown) having a hollow cavity 14 therein.

### 3. Making Hollow Dental Models.

One embodiment of a method of making a dental appliance thermoforming mold, is set forth in portions of the flow chart given as FIG. 7A. The method includes the step of providing initial object image data (51) representing a mold in the shape of a dental arch (10), the mold as described above. Any suitable data file, such as a .stl file, CAD file, or substitute therefore, may be used. Drain channel data and/or instructions 52 are also provided.

If not already included in the data file, the method may include the step of generating (53) the hollow cavity (14) in the initial object image data.

From the foregoing, the initial object image data is combined (54) with the drain channel data and/or drain channel instructions to create a modified object image data (such as a new .stl file) representing the mold, with the mold now further comprising a plurality of drain channels (15) as described above (and their corresponding exterior and interior openings (16, 17)). These steps are typically carried out in a (local or remote) computer, and a non-limiting example of these steps is given in Examples 2-4 below.

As an alternative to creating a new .stl file, the holes may be “drilled” during the additive manufacturing process itself, for example by modification of .png files during or after slicing of an .stl file, as noted above and illustrated in FIG. 7B.

The method then continues with the additive manufacturing of the molds, typically as a group of molds manufactured simultaneously, and as discussed further in section 4 below.

4. Making Dental Appliances with Hollow Dental Models.

In some embodiments, and as shown in FIG. 7A Process Part B, a method of making dental appliances begins with additively manufacturing (55) a plurality of molds as described herein above from a light polymerizable resin on a build platform 20, with each the at least one mold oriented horizontally on the build platform with the bottom surface portion 13 adhered to the build platform surface 21.

Additive manufacturing, resins and resin viscosity. Suitable additive manufacturing techniques include but are not limited to those set forth above. Any suitable build platform 20 can be used, including but not limited to that described in Dachs, Removable build platform for an additive manufacturing apparatus, PCT Patent Application Pub. No. WO2020/069167 (Sep. 26, 2019). Build platforms generally have a planar top surface 21 to which the bottom surface is adhered, directly, or indirectly through a release sheet.

In some embodiments, the build platform has an adhesive release sheet applied to the planar top surface thereof, on which the thermoforming molds are additively manufactured. In some embodiments, the release sheet is, preferably comprised of a light-transmissive polymer material, as described in X. Gu, PCT Patent Application Pub. No. WO 2018/118832 (published 28 Jun. 2018). In such embodiments the exposed surface of the release sheet is considered as the top surface 21 of the platform.

Any suitable resin can be used, with numerous alternatives available. Resins chosen will generally have a known viscosity, and the size and shape of drain channels, interior and exterior surface openings, and the speed of centrifugation can be adjusted based on that viscosity (and vice versa). For example, in some embodiments (such as those with smaller diameter drain channels and/or exterior surface openings), the resin may have a Brookfield viscosity of not more than 500 or 1000 centipoise at a temperature of 25 degrees Centigrade (for example, as measured by a procedure as set forth in Example 1). In other examples (such as those with larger diameter drain channels and/or exterior surface openings), the resin may have a Brookfield viscosity of at least 1000 or 2000 centipoise at a temperature of 25 degrees Centigrade (again, for example, as measured by a procedure as set forth in Example 1).

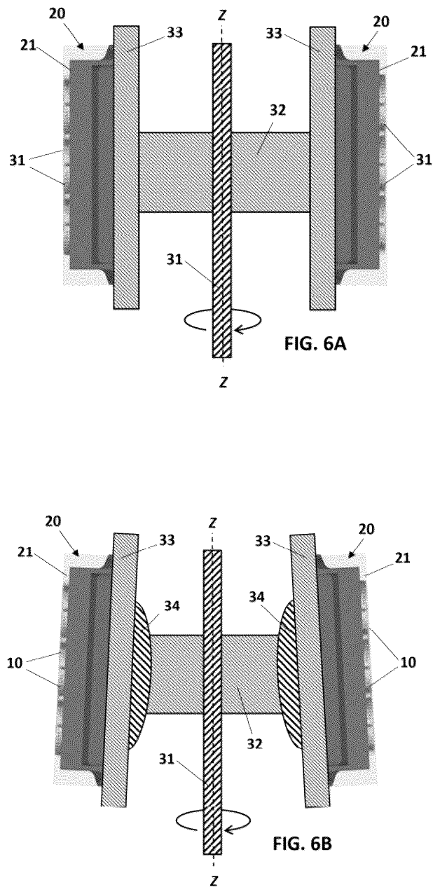

Centrifugal separation. Next, referring again to FIG. 7A, residual resin is centrifugally separated (56) from the molds. Centrifugal separation of residual resin is known and described in Murillo and Dachs, Resin extractor for additive manufacturing, US Patent App. Pub. No. 2021/0086450 (Mar. 25, 2021); Hiatt et al., Method for removing and reclaiming unconsolidated material from substrates following fabrication of objects thereon by programmed material consolidation techniques, US Patent App. Pub. No. 2004/0159340 (Aug. 19, 2004); and Converse et al., Systems and methods for resin recovery in additive manufacturing, PCT Patent App. Pub. No. WO 2020/146000 (Jul. 16, 2020). In the processes described herein, residual resin is separated during the centrifugal separating step from both the upper surface portion and the hollow cavity of each the mold while on the build platform by spinning the build platform around an axis of rotation (Z-Z), with the upper portion of the at least one mold facing away from the axis of rotation as schematically illustrated in FIGS. 6A-6B, with resin flow out of the hollow cavity indicated in FIG. 8 by dashed arrows.

The drain channels described herein allow the centrifugally separating step to be carried out by only spinning the build platform around an axis of rotation with the upper portion of the at least one mold facing away from the axis of rotation (that is, without an additional step of spinning the build platform with the upper portion facing towards the axis of rotation.). This advantageously speeds and simplifies the overall production process. Speed and duration of the spinning and the temperature during centrifugation (in some embodiments preferably ambient or room temperature) can all be determined in accordance with known techniques. Note that, in the schematic illustrations of FIGS. 6A-6B, a rotor 31 defines the axis of rotation Z-Z, about which build platforms 20 rotate. The build platforms are typically removably fixed to a build platform mount 33, which is in turn connected to a rotor mount 32 to connect back to the rotor. The build platforms may be positioned vertically with respect to the axis of rotation (e.g., with the build surface 21 parallel to the axis of rotation Z-Z) as in FIG. 6A, or tilted (e.g., by means of an adjustable component 34) as in FIG. 6B.

Speed and duration of the centrifugal separation/spinning step will vary depending upon factors including (but not limited to) the size and shape of the build platforms, the size of the apparatus, the viscosity of the residual resin, the accuracy required for the product, the temperature at which the centrifugal separation is carried out, etc. In some embodiments, spinning is carried out for a time of 0.5, 1 or 2 minutes to 10, 30 or 60 minutes (these times not including ramp-up from rotor stationary status to sustained maximum speed of rotation, and corresponding ramp-down from sustained maximum speed to rotor stationary status) at a maximum speed of 100, 200, 400 or 500 revolutions per minute (rpm), up to 700, 1,000, 5,000, or 10,000 rpm. While the apparatus can be made in any suitable size, from small table-top apparatus to large industrial apparatus, the apparatus will typically be constructed so that the centers of gravity of the build platforms spin in a circle having a diameter of 5, 10, or 20 centimeters, to 2 or 6, or 10 meters.

Additional steps. Referring again to FIG. 7A, the process continues in accordance with known techniques by further curing (57), concurrently or sequentially, the external surface portion and the bottom portion of each the plurality of molds with actinic radiation or light (e.g., ultraviolet light); then thermoforming (58) a thermoplastic polymer sheet (such as a clear thermoplastic polymer sheet) on each mold external surface portion to produce the plurality of polymer dental appliances; and then separating (59) the plurality of polymer dental appliances from each the mold. Additional steps such as further cleaning and trimming the appliances can be included in accordance with known techniques.

Types of appliances. Any of a variety of types of polymer dental appliances can be produced, including but not limited to orthodontic aligners, orthodontic retainers, orthodontic splints, dental night guards, dental bleaching (or whitening) trays, and combinations thereof. In some embodiments, the plurality of polymer dental appliances comprises at least one progressive set of dental appliances (e.g., a progressive set of dental aligners) for a specific patient.

The following examples are provided to further illustrate particular aspects of the products and methods described herein, and are not to be taken as limiting.

### Example 1

### Resin Viscosity Measurement

The viscosity of resins can be measured at 25 degrees Centigrade using a Brookfield viscometer (Model DV1) equipped with an SC4-31 spindle. A bubble-free sample (9.0 g) is poured into the sample chamber and the temperature is equilibrated for 15 minutes. After equilibration, the RPM of the spindle is adjusted to target a torque of approximately 50% (RPM of roughly 3.0-1.5 depending on the sample viscosity), where the viscosity is measured.

### Example 2

### Drain Channel Placement

Drain channels may be placed by a method as follows, preferably carried out as a program running on a computer or other processor:

1. Locate the local maxima resolved in the printing direction of the interior hollow cavity of the arch.

2. For each identified local maximum, locate a point on the exterior surface of the arch.
a. These points may be the points immediately above the local maxima (as in FIG. 4A, where the previous local maxima is shown by the dotted line).
b. These points may be defined as the points on the exterior surface of the arch closest in space to each local maximum (as in FIG. 4B).
c. These points may be defined as any convenient point on the surface of the arch that would allow for the best flow of resin out of the vent (not shown).

3. Compute the vectors that connect the points from 1, with the points from 2.

4. Remove material from the arch exterior (where “interior” refers to the hollow cavity and “exterior” refers to the solid shell or body) that is within a specified region around each vector defined in 3.
a. These regions may be defined as cylinders whose axes are parallel with the vectors in 3., having a specified radius, and lengths equivalent to the vectors in 3.
b. These cylinders may have variable radii, either from one cylinder to the next or within a single cylinder (as in FIG. 4A).
c. The region may be defined as a cone that tapers as it approaches the exterior surface of the arch (as in FIG. 4B).

### Example 3

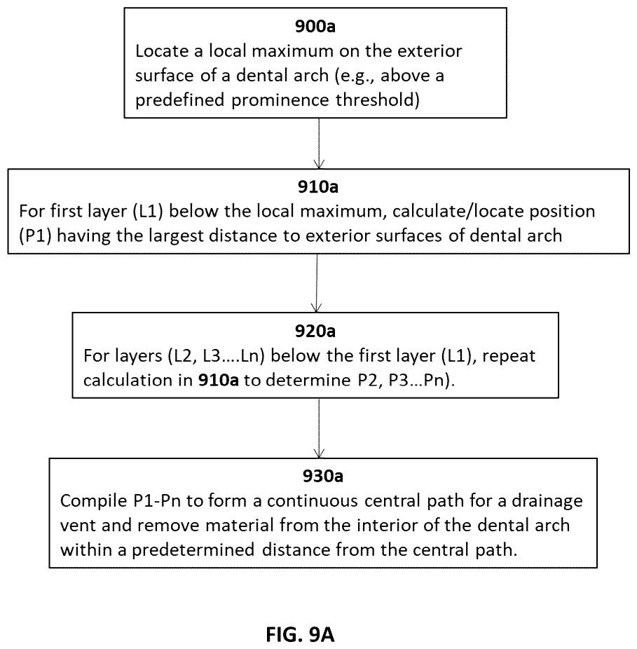

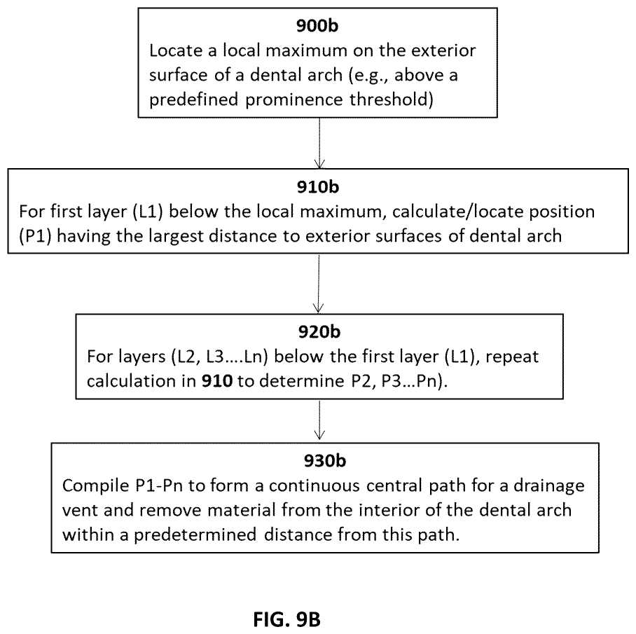

Another computer processing method for determining the location and size of the drain channels is shown in FIG. 9A. First a model for a dental arch is provided. Then, referring to step 900a, a local maximum on the external surface of the dental arch is located. For example, the local maximum may be determined based on a predefined prominence threshold in the Z direction. Then, referring to step 910a, for the first layer (L1) below the local maximum (e.g., a depth of 100 to 300 microns), a position having the largest distance from one or more exterior surfaces of the dental arch (P1) is determined/calculated. Next, referring to step 920a, for each layer below the first layer (L2, L3 . . . . Ln), the position having the largest distance from one or more exterior surfaces of the dental arch (P2, P3 . . . . Pn, respectively) is determined. For example, taking into account all external surfaces on the tooth, the positions may be the most internal position available at each layer. The layers may be uniform or their depth may vary. Referring to step 930a, the calculated positions for each layer are then compiled to form a continuous path for a drain channel. The computer/algorithm may then determine the amount of material to remove within a certain distance from the determined central path. For example, material may be removed so that at each point in the central path, a certain wall thickness (e.g., 75 microns to 3 mm) is maintained. In addition, the wall thickness may be varied throughout the defined drainage path. For example, in some embodiments, the processor may assign smaller wall thicknesses (e.g., minimum wall thicknesses) to layers toward the top/exterior surface portion of the dental arch (e.g., 75-500 microns, including 75, 100, 200, 300, 400, 500 microns, and any range defined therebetween) and larger wall thickness (e.g., minimum wall thicknesses) to layers closer to the base or hollow cavity of the dental arch (e.g., 1-3 mm).

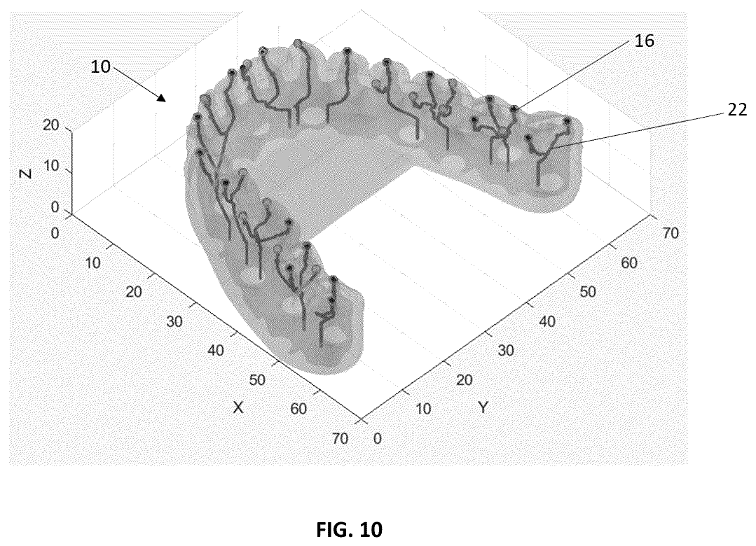

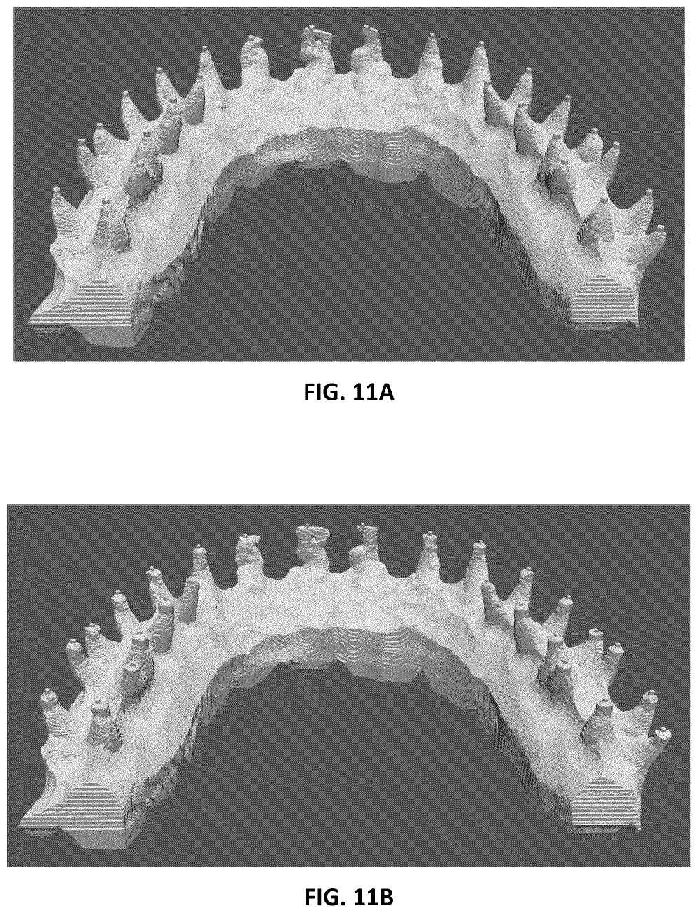

Multiple drainage paths on a single dental arch may be formed. FIG. 10 shows drainage paths 22 formed in a dental arch 10 by this method. Note that exterior surface openings 16 are located at local maxima in the dental arch 10. FIGS. 11A and 11B show molds from the hollow internal portion of such dental arches in order to better illustrate the shape of the hollow portions within the dental arches.

### Example 4

Another computer processing method for determining the location and size of the drain channels is found in FIG. 9B. In this example, a similar layer-by-layer approach is used but the algorithm/computer processor begins with a local maximum on the interior surface of the hollow volume in the dental arch. First a model for a dental arch is provided. Then, referring to step 900b, a local maximum on the interior surface of the hollow volume in the dental arch is located. Next, referring to step 910b, for the first layer (L1) above the local maximum (e.g., a depth of 100 to 300 microns), a position having the largest distance from one or more exterior surfaces of the dental arch (P1) is determined/calculated. Then, referring to step 920b, for each layer above the first layer (L2, L3 . . . . Ln), the position having the largest distance from one or more exterior surfaces of the dental arch (P2, P3 . . . . Pn, respectively) is determined. Referring to step 930b, the calculated positions for each layer are then compiled to form a continuous central path for a drain channel. The computer/algorithm may then determine the amount of material to remove within a certain distance from the determined drain path in the same manner described in Example 3.

The foregoing is illustrative of the present invention and is not to be construed as limiting thereof. The invention is defined by the following claims, with equivalents of the claims to be included therein.

We claim:

1. A mold in the shape of a dental arch produced by additive manufacturing from a polymerizable resin, said mold comprising:
an upper portion configured in the shape of a set of teeth;
an intermediate portion having a hollow cavity formed therein;
a planar base surface portion, said hollow cavity extending through said base surface portion; and
a plurality of drain channels extending from said hollow cavity upward through said upper portion, said drain channels configured for draining of residual polymerizable resin from said hollow cavity.

2. The mold of claim 1, wherein said hollow cavity extends into said upper portion.

3. The mold of claim 1, wherein said hollow cavity displaces at least 30 or 40 percent up to 60 or 80 percent, of the total volume of said mold (as compared to the same mold without said hollow cavity).

4. The mold of claim 1, wherein said plurality of drain channels have an average diameter at said upper portion of at least 50, 70, 80, 90, or 100 microns.

5. The mold of claim 1, wherein said plurality of drain channels terminate at an exterior surface opening having an average diameter at said upper portion of not more than 300, 400, or 500 microns; and optionally wherein said plurality of drain channels originate at an interior surface opening having an average diameter not less than (and in some embodiments greater than) the average diameter of said exterior surface opening.

6. The mold of claim 1, wherein said plurality of drain channels comprise at least 10, 20, 30, or 40 drain channels.

7. The mold of claim 1, wherein said plurality of drain channels comprise not more than 100, 200, or 300 drain channels.

8. The mold of claim 1, wherein said plurality of drain channels are oriented, on average, at an angle offset from vertical, with respect to said planar base surface portion, of not more than 5, 10, 15, or 20 degrees (e.g., as measured directly from said interior surface opening to said exterior surface opening).

9. The mold of claim 1, wherein:
said plurality of drain channels are oriented substantially vertically with respect to said planar base surface portion along at least a major portion of the length thereof; and/or
at least a portion of said drain channels are oriented substantially perpendicularly with respect to the surface of said upper portion surrounding the exterior surface opening of said drain channel (that is, are oriented normal with respect to the surface, to thereby reduce the diameter of the exterior surface opening, as compared to a surface opening for an entirely vertical drain channel).

10. The mold of claim 1, wherein at least a portion of said drain channels include a bend.

11. The mold of claim 1, wherein at least a portion of said drain channels are configured in the shape of a residual resin trap (e.g., an “S” shaped trap or a “P” shaped trap).

12. The mold of claim 1, wherein the height of said cavity, with respect to said base surface portion, is:
(i) substantially the same throughout said arch, or
(ii) contoured through said arch in a configuration that, in cooperation with said drain channels, facilitates the flow of residual resin out of said hollow cavity during centrifugation thereof.

13. The mold of claim 1 produced by the process of additive manufacturing from a light polymerizable resin.

14. A method of making a plurality of polymer dental appliances, comprising the steps of:
(a) additively manufacturing a plurality of molds of claim 1 from a light polymerizable resin on a build platform surface portion, with said molds oriented horizontally on said build platform with said mold bottom surface portion adhered to said build platform surface portion (directly, or through an intervening release sheet);
(b) centrifugally separating residual resin from both said upper surface portion and said hollow cavity of each said mold while on said build platform by spinning said build platform around an axis of rotation, with said upper portion of said at least one mold (and/or said build platform surface portion) facing away from said axis of rotation;
(c) further curing, concurrently or sequentially, said external surface portion (e.g., said upper portion and said intermediate portion) and said bottom portion of each said plurality of molds with actinic radiation or light (e.g., ultraviolet light); then
(d) thermoforming a thermoplastic polymer sheet on each said mold external surface portion to produce said plurality of polymer dental appliances; and
(e) separating said plurality of polymer dental appliances from each said mold.

15. The method of claim 14, wherein said plurality of polymer dental appliances comprise orthodontic aligners, orthodontic retainers, orthodontic splints, dental night guards, dental bleaching (or whitening) trays, or a combination thereof.

16. The method of claim 14, wherein said plurality of polymer dental appliances comprises at least one progressive set of dental appliances (e.g., a progressive set of dental aligners) for a specific patient.

17. The method of claim 14, wherein said thermoplastic polymer sheet comprises a clear polymer sheet.

18. The method of claim 14, wherein said centrifugally separating step is carried out only by spinning said build platform around an axis of rotation with said upper portion of said at least one mold (and/or said build platform surface portion) facing away from said axis of rotation (that is, without spinning said build platform with said upper portion facing towards said axis of rotation.).

19. A method of making a dental appliance thermoforming mold, comprising the steps of:
(a) providing initial object image data representing a mold in the shape of a dental arch, said mold comprising:
(i) an upper portion configured in the shape of a set of teeth;
(ii) an intermediate portion, the intermediate portion optionally including a hollow cavity formed therein; and
(iii) a planar base surface portion, said hollow cavity when present extending through said base surface portion;
(b) providing drain channel data, drain channel instructions, or a combination thereof;
(c) optionally generating said hollow cavity in said initial object image data if not previously present therein; and
(d) combining (before or after said optionally generating step (c) if included) said initial object image data with said drain channel data, drain channel instructions, or combination thereof to create a modified object image data representing said mold, with said mold now further comprising:
(iv) a plurality of drain channels extending from said hollow cavity upward through said surface portion (e.g., said upper portion) configured for draining of residual polymerizable resin from said hollow cavity.

20. The method of claim 19 carried out in or implemented by a computer.

21. The method of claim 19, further comprising:
(e) additively manufacturing a plurality of molds from a light polymerizable resin and a plurality of said modified object image sequences on a build platform, with each said mold oriented horizontally on said build platform with said bottom surface portion adhered to said build platform; and then
(f) centrifugally separating residual resin from both said upper portion and said hollow cavity of each said mold while on said build platform by spinning said build platform around an axis of rotation, with said upper portion of each said mold facing away from said axis of rotation.

22. The method of claim 21, further comprising:
(g) further curing, concurrently or sequentially, said external surface portion (e.g., said upper portion and said intermediate portion) and said bottom portion of each said plurality of molds with actinic radiation or light (e.g., ultraviolet light); then
(h) thermoforming a thermoplastic polymer sheet on each said mold external surface portion to produce said plurality of polymer dental appliances; and
(i) separating a plurality of polymer dental appliances from each said mold.

23. The method of claim 19, wherein said hollow cavity extends into said upper portion.

24. The method of claim 19, wherein said hollow cavity displaces at least 30 or 40 percent up to 60 or 80 percent, of the total volume of said mold (as compared to the same mold without said hollow cavity).

25. The method of claim 19, wherein said plurality of drain channels have an average diameter at said upper portion of at least 50, 70, 80, 90, or 100 microns.

26. The method of claim 19, wherein said plurality of drain channels terminate at an exterior surface opening having an average diameter at said upper portion of not more than 300, 400, or 500 microns; and optionally wherein said plurality of drain channels originate at an interior surface opening having an average diameter not less than (and in some embodiments greater than) the average diameter of said exterior surface opening.

27. The method of claim 19, wherein said plurality of drain channels comprise at least 10, 20, 30, or 40 drain channels.

28. The method of claim 19, wherein said plurality of drain channels comprise not more than 100, 200, or 300 drain channels.

29. The method of claim 19, wherein said plurality of drain channels are oriented, on average, at an angle offset from vertical, with respect to said planar base surface portion, of not more than 5, 10, 15, or 20 degrees (e.g., as measured directly from said interior surface opening to said exterior surface opening).

30. The method of claim 19, wherein:
said plurality of drain channels are oriented substantially vertically with respect to said planar base surface portion along at least a major portion of the length thereof; and/or
at least a portion of said drain channels are oriented substantially perpendicularly with respect to the surface of said upper portion surrounding the exterior surface opening of said drain channel (that is, are oriented normal with respect to the surface, to thereby reduce the diameter of the exterior surface opening, as compared to a surface opening for an entirely vertical drain channel).

31. The method of claim 19, wherein at least a portion of said drain channels include a bend.

32. The method of claim 19, wherein at least a portion of said drain channels are configured in the shape of a residual resin trap (e.g., an “S” shaped trap or a “P” shaped trap).

33. The method of claim 19, wherein the height of said cavity, with respect to said base surface portion, is:
(i) substantially the same throughout said arch, or
(ii) contoured through said arch in a configuration that, in cooperation with said drain channels, facilitates the flow of residual resin out of said hollow cavity during centrifugation thereof.
